(19) United States
(12) Patent Application Publication
(10) Pub. No.: US 2019/0232095 A1
(43) Pub. Date: Aug. 1, 2019

(54) Fire Extinguishing Device for Installation in an Area and for Fighting Fires in Multiple Sectors of the Area and a Fire Extinguishing System Comprising Same

(71) Applicant: MlNIMAX GMBH & CO. KG, Bad Oldesloe (DE)

(72) Inventors: Klaus HOFMANN, Bad Oldesloe (DE); Joachim BÖKE, Düsseldorf (DE); André LICKEFETT, Herrnberg (DE)

(21) Appl. No.: 16/316,511

(22) PCT Filed: Jul. 5, 2017
(86) PCT No.: PCT/EP2017/066832

§ 371 Date: Jan. 9, 2019

(30) Foreign Application Priority Data
Jul. 11, 2016 (DE) 10 2016 212 612.1

(51) Int. Cl. A62C 31/05; A62C 35/68; A62C 37/40

(52) U.S. Cl. CPC A62C 31/05; A62C 37/40; A62C 35/68

(57) ABSTRACT

The invention concerns a fire extinguishing device (1; 1′) for installation in a room (200) and for fighting fires in a plurality of sectors of the room, comprising a housing (7) having an extinguishing fluid inlet (3), wherein the housing has a plurality of extinguishing fluid outlets (5a-f) connected fluidically to the extinguishing fluid inlet.

According to the invention it is proposed that the extinguishing fluid outlets (5a-f) are adapted to discharge an extinguishing fluid along a respective individual extinguishing fluid trajectory (101a-f), are oriented fixedly on the housing in such a way that the extinguishing fluid trajectories from the extinguishing fluid outlets cover respectively different sectors (203a-f) of the room, and associated with the extinguishing fluid outlets is a respective control member (17a-f) for selectively opening or closing the connection between the extinguishing fluid inlet and the extinguishing fluid outlet.

The present invention concerns a fire extinguishing device for installation in a room which has a plurality of sectors and for fighting fires in the sector of the room, comprising a housing having an extinguishing fluid inlet, wherein the housing has a plurality of extinguishing fluid outlets fluidically connected to the extinguishing fluid inlet. The invention further concerns a fire extinguishing system for a room which has a plurality of sectors, comprising an extinguishing fluid supply and at least one fire extinguishing device fluidically connected to the extinguishing fluid supply.

Fire extinguishing devices and fire extinguishing systems of the above-indicated kind are generally known, for example from US 2016/0059057 A1 or U.S. Pat. No. 5,727,634 A. The above-indicated documents each disclose fire extinguishing devices in which extinguishing fluid is discharged from a plurality of extinguishing fluid outlets. The known devices however suffer from the disadvantage that they do not permit specifically targeted actuation of different extinguishing fluid outlets for delivering extinguishing agent to different sectors. U.S. Pat. No. 5,727,634 A only concerns the discharge of extinguishing agent from all openings simultaneously in different directions in space. Targeted extinguishing in a given sector of the room is not possible therewith. US 2016/0059057 A1 in contrast discloses a plurality of individual jets of an extinguishing fluid which are directed convergently towards each other in order to produce therefrom a single directed jet of extinguishing agent. This too does not permit a plurality of room sectors to be targetedly supplied with extinguishing agent.

In addition the state of the art using the term “monitor” discloses fire extinguishing devices for installation in a room, in which an individual extinguishing fluid outlet is respectively arranged pivotably in the room in order in dependence on detection of a local source of fire to be directed thereto, to respectively apply extinguishing agent at that location. Such devices admittedly permit quite targeted extinguishing of a fire, but the apparatus complication and expenditure, because of the necessary mechanism, is disproportionately high so that practical use in rooms is not attractive.

Accordingly the object of the invention is to improve a fire extinguishing device and fire extinguishing system of the kind set forth in the opening part of this specification, such that the above-described disadvantages are overcome to the greatest possible extent. In particular the object of the invention is to improve a fire extinguishing device and fire extinguishing system of the kind indicated in the opening part of this specification such that precisely located extinguishing is now possible with at the same time an arrangement which is structurally as simple as possible and in particularly compact.

The invention attains its object in respect of a fire extinguishing device of the kind set forth in the opening part of this specification with the features of claim 1. The invention proposes a fire extinguishing device in which the extinguishing fluid outlets are adapted to deliver an extinguishing fluid along a respective individual extinguishing fluid trajectory and are oriented fixedly on the housing in such a way that the extinguishing fluid trajectories from the outlets in the installed condition of the fire extinguishing device respectively cover different sectors of the room, and a control member is respectively associated with the extinguishing fluid outlets for selectively opening or closing the connection between extinguishing fluid inlet and extinguishing fluid outlet. According to the invention the term trajectory is used to denote a function of the extinguishing fluid pressure and/or the geometry of the extinguishing fluid outlet. The trajectory is selected from a group of trajectories in dependence on the above-indicated parameters in order to cause extinguishing fluid to impinge on a predetermined part of the sector. According to the invention the term sector is used to denote a flat and/or spatial portion of the room, wherein adjacent sectors can overlap each other but are not disposed in congruent relationship one upon the other.

The invention makes use of the realization that a fire in a room can not always start only at a single fire source, but can equally extend over a plurality of sectors or in a very short period of time the fire source is localized in a two or more sectors, or fire sources can arise at the same time or in quick succession even in a plurality of sectors in the room. It is possible with the structure according to the invention for each of the sectors in which fire sources are detected to be covered with a dedicated extinguishing fluid trajectory insofar as the extinguishing fluid outlet associated with the respective extinguishing fluid trajectory is opened selectively for outlet and discharge of extinguishing fluid. Therefore one or more control members can be actuated selectively according to the invention for opening or closing the communication between extinguishing fluid inlet and extinguishing fluid outlet. That makes it possible for one or more fire sources to be extinguished in specifically targeted relationship without having to provide expensive moveable extinguishing nozzles and at the same time with a single housing which has an extinguishing fluid inlet and a plurality of extinguishing fluid outlets to be able to provide a highly compact structure which at the same time can be installed in the room at a low level of complication and expenditure. Further advantages of the invention is that selective opening of the connection permits locally precise extinguishing with a low level of extinguishing agent consumption. Consequential damage due to the extinguishing agent is minimized. In addition the selective opening of one or more extinguishing nozzles also allows the involvement of a plurality of, preferably overlapping, sectors if a fire source is detected at the intersection of two or more sectors.

An advantageous development of the invention provides that the control members are adapted for individual, preferably stepless, control of the pressure of the extinguishing fluid discharged through the extinguishing fluid outlets. The range of the respective extinguishing fluid trajectory is specifically controlled by controlling the extinguishing fluid pressure.

In a preferred embodiment of the invention the fire extinguishing device at least one sensor device, preferably a plurality of sensor devices, for localization that or those sectors of the room, that have a source of fire and for producing localization data in respect of those sectors. The term fire source is intended to mean in that respect an already existing fire source or a potentially future fire source which has been located for example on the basis of unusual emissions of values relating to the heart of the fire. According to the invention the term values relating to the heart of a fire is used to mean electromagnetic radiation, in particular in the UV and/or IR wavelength range, aerosols (in particular smoke aerosols), temperatures, gas concentration levels, gas compositions and/or changes in concentration of certain gaseous constituents of conflagration gases, thermal decomposition products, and toxic or combustible gases.

In a further preferred embodiment the fire extinguishing device has a data interface for actuation of the control members by means of an external electronic control device. The control members are preferably adapted to receive data from the external electronic control device by means of the data interface. The control commands include at least opening and closing of the control members. Signal transmission between the control members and the control device is preferably effected by means of wireless or wired data transmission by way of the data interface.

As an alternative to the above-described central control configuration in a preferred alternative the fire extinguishing device internally has an electronic control device which is connected in signal-conducting relationship to the at least one sensor device on the one hand and the control members on the other hand, wherein the at least one sensor device is adapted to communicate the localization data to the electronic control device. The internal control device is preferably either integrated directly into the housing of the fire extinguishing device or is disposed in a separate dedicated housing.

Equally the external electronic control device of the alternative embodiment can be arranged in a dedicated housing in the room or can be integrated into a fire alarm and/or extinguishing control center which can also be arranged remotely from the room being monitored.

According to a further preferred configuration the electronic control device is adapted on the basis of the localization data to identify one or more of the extinguishing fluid outlets whose respective extinguishing fluid trajectory covers a localized sector, to open the identified extinguishing fluid outlet or outlets.

Further preferably the electronic control device is adapted on the basis of the received localization data to track the extinguishing process, in addition to the identified extinguishing fluid outlet or outlets to open one or more further, in particular respectively adjacent, extinguishing fluid outlets, and to close one, several or all extinguishing fluid outlets. In particular the extinguishing fluid outlets are closed when the electronic control device, with incorporation of the localization information from the sensor devices, has determined that extinguishing success has been achieved in the sectors being covered. The electronic control device preferably infers that extinguishing success has taken place by the sensor device or devices which had previously sensed the presence of a value in respect of the heart of the fire no longer sensing the presence of a value in respect of the heart of the fire for a predetermined period of time. Values for the predetermined period of time can be for example in the range of 1 second to 10 seconds, preferably for very small incipient fires, or preferably in the range of 5 seconds to 60 seconds for for example small incipient fires, or preferably in the range of 60 seconds to 600 seconds for larger fires, or, in the event of a risk of reignition, preferably in the range of 600 seconds to 900 seconds.

In the foregoing embodiments the fact that the control members can be at least digitally actuated, that is to say either open the extinguishing fluid outlet or close it, was respectively paramount. In a preferred embodiment the control members each have a respective throttle, preferably in the form of an aperture means, for adjusting the pressure of the issuing extinguishing fluid. By targeted adjustment of the issuing extinguishing fluid pressure the speed of discharge of the extinguishing fluid and thus the range of the extinguishing fluid trajectory can be specifically influenced.

Preferably the throttles, in particular aperture means, are in the form of replaceable elements. Particularly preferably the throttles, in particular aperture means, each have a respective adjusting means for altering the throttle width, in particular the aperture means size. The adjusting means is preferably connected in signal-conducting relationship to the respective electronic control device and the electronic control device is adapted to control the throttle width of the respective control members in dependence on the received localization information.

Examples of the control of an aperture means could be: reducing the aperture size if the fire source is at a short distance in relation to the device, and increasing the aperture size if the fire source is further away from the device.

In preferred embodiments the fire extinguishing device for each control member has a plurality of aperture means which can be selectively used and which permit stepped adjustment. Preferably the aperture means are provided in throttle cassettes or in the form of a rotary disc having a plurality of aperture openings, a respective one of each of which is disposed in the flow of fluid while the other openings are outside the flow of fluid.

In another preferred embodiment the adjusting means is adapted for stepless adjustment of the aperture size, for example by the aperture means having a plurality of aperture blades which are displaceable by means of an iris ring.

In a further preferred embodiment the control members are each of a respective discharge cross-section adapted for discharge of an extinguishing fluid pattern which enlarges in the direction of the extinguishing fluid trajectory. The extinguishing fluid pattern which enlarges in the direction of the extinguishing fluid trajectory is preferably an extinguishing fluid cone, or a truncated cone or cone which is “curved” as a result of the force of gravity in the direction of the extinguishing fluid trajectory. The consequence of enlargement of the extinguishing fluid pattern is that the sector being covered becomes correspondingly wider for the respective extinguishing fluid outlet, in proportion to an increasing distance in relation to the extinguishing fluid outlet.

Preferably the control members each have a “rotatable disc” involving a plurality of different geometry elements, for example through openings, a respective one of which is disposed in the fluid path of the extinguishing fluid nozzle near the outlet cross-section. Alternatively the control members respectively have a preferably replaceable insert which defines a predetermined enlargement of the extinguishing fluid flow corresponding to a desired extinguishing fluid pattern. Further alternatively the control members respectively have a displaceable cover means involving a plurality of different geometry elements, for example through openings, a respective one of which is introduced into the fluid path of the extinguishing fluid nozzle.

In a further preferred embodiment all extinguishing fluid outlets are oriented in mutually divergent relationship. That expression is used to mean that between respectively adjacent extinguishing fluid outlets, an angle is defined between the respective center lines of the outlet cross-sections. The extinguishing fluid outlets in this embodiment are not oriented in mutually parallel relationship so that room coverage which is great as possible can be achieved with a number of extinguishing fluid outlets, that is as small as possible. In an alternative preferred configuration in which the fire extinguishing device has three or more extinguishing fluid outlets, two or more first extinguishing fluid outlets are oriented in mutually parallel relationship and one or more second extinguishing fluid outlets are oriented in mutually parallel relationship but divergent in relation to the first extinguishing fluid outlets. Particularly preferably this configuration provides that the housing of the fire extinguishing device is cylindrical. Alternatively the housing is of a polygonal shape, in which case the housing in particular is of a polygonal tubular cross-section, in which a number of extinguishing fluid outlets are arranged on each individual lower surface, the outlets being parallel to each other but not parallel to the extinguishing fluid outlets of the adjoining surfaces.

In a further preferred embodiment the fire extinguishing device has a pressure regulator which is fluidically interposed between the extinguishing fluid inlet and the extinguishing outlets and which is adapted to increase or reduce, preferably selectively, the extinguishing fluid pressure at the inlet side. The pressure regulator is preferably connected in signal-conducting relationship to the electronic control device, the electronic control device preferably being adapted to actuate the pressure regulator in dependence on the received localization information to increase or reduce the extinguishing fluid pressure. Alternatively the pressure regulator is provided upstream of the extinguishing fluid inlet and interposed between the extinguishing fluid supply and the extinguishing fluid inlet of the fire extinguishing device. In a preferred embodiment the pressure regulator can be integrated in the interior of the housing, but however can also be disposed externally in a separate dedicated housing.

According to a further preferred configuration of the fire extinguishing device the at least one sensor device or the plurality of sensor devices is or are arranged in a separate housing, spaced in relation to the housing of the fire extinguishing device, preferably at different positions within the room. The spacing between the sensor devices or the sensor device and the housing (and possibly the sensor devices from each other) is preferably so selected that optical impairment of the field of view of the sensor device or devices by issuing extinguishing fluid is minimized. The arrangement of a plurality of sensor devices per se already contributes to avoiding dead angles and to improving spatial localization by means of triangulation.

In a particularly preferred embodiment the fire extinguishing device is provided for installation of the housing at an object, a wall or a ceiling of the room and for that purpose has corresponding fixing means.

As mentioned in the opening part of this specification the invention further concerns a fire extinguishing system. In the case of a fire extinguishing system of the kind set forth in the opening part of this specification the object of the invention is attained in that the fire extinguishing device is in accordance with one of the above-described preferred embodiments. The fire extinguishing device is installed in a room having a plurality of sectors so that the extinguishing fluid outlets on the housing respectively cover different sectors of the room. The fire extinguishing system preferably includes a fire alarm and/or extinguishing control center connected in signal-conducting relationship to the fire extinguishing device or devices. A fire extinguishing system is particularly preferred, in which the fire extinguishing device or devices do not have individual sensor devices and electronic control devices, but in which the fire extinguishing system has a central external electronic control device and a number of sensor devices, wherein the sensor devices communicate with the central electronic control device and the electronic control device in turn communicates with the control members of the one or more fire extinguishing devices for the purposes of actuation thereof. The external control device is preferably installed in the room or alternatively remote from the room, for example being integrated into a fire alarm and/or extinguishing control center.

An advantageous development of both configurations of the fire extinguishing system is achieved in that the extinguishing fluid supply is a water supply installed in a building, or is in the form of a pressurized extinguishing fluid supply or is in the form of a pressure-less container connected to a separately provided pressurised propellant container and the extinguishing agent of which can be expelled by means of the propellant.

The invention is described in greater detail hereinafter by means of preferred embodiments by way of example with reference to the accompanying Figures in which:

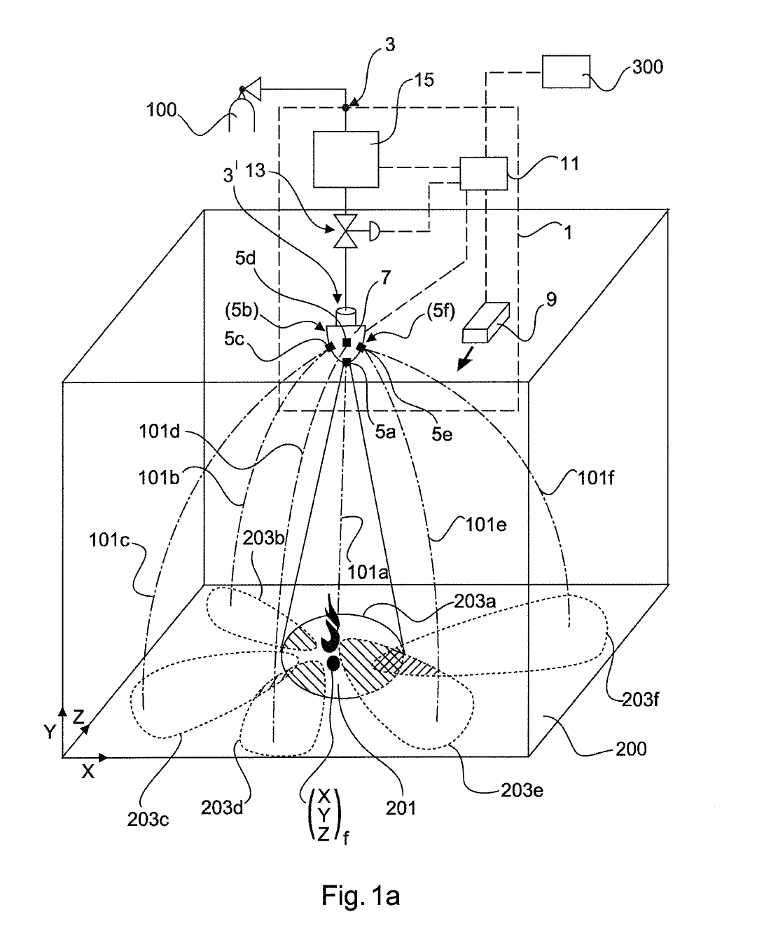

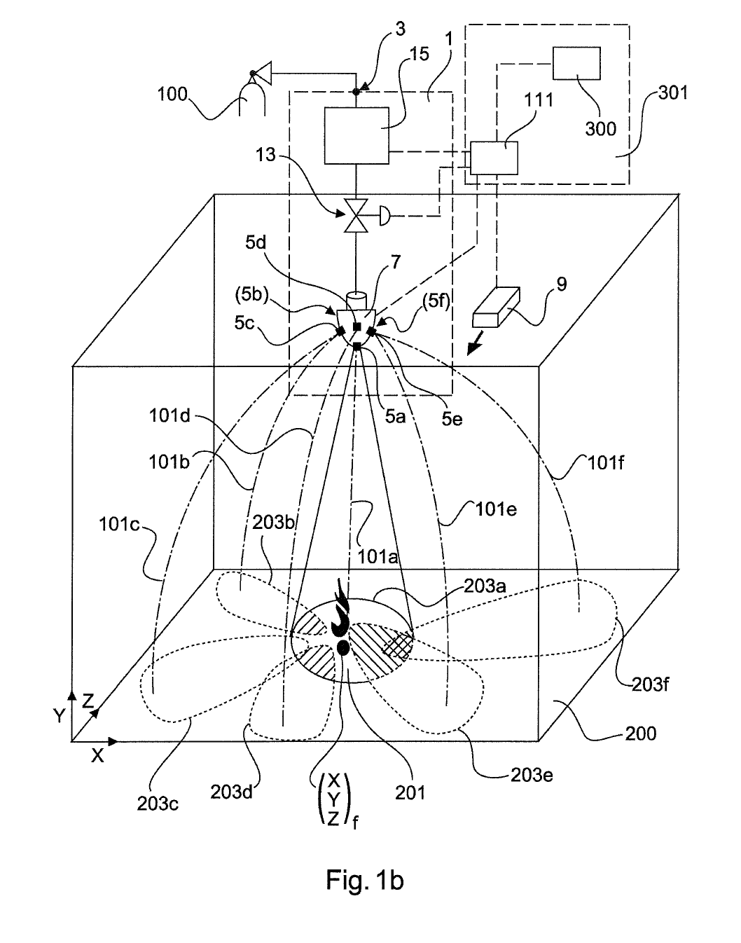

FIG. 1a shows a diagrammatic view of a fire extinguishing system according to a first embodiment,

FIG. 1b shows a diagrammatic view of a fire extinguishing system according to a second embodiment,

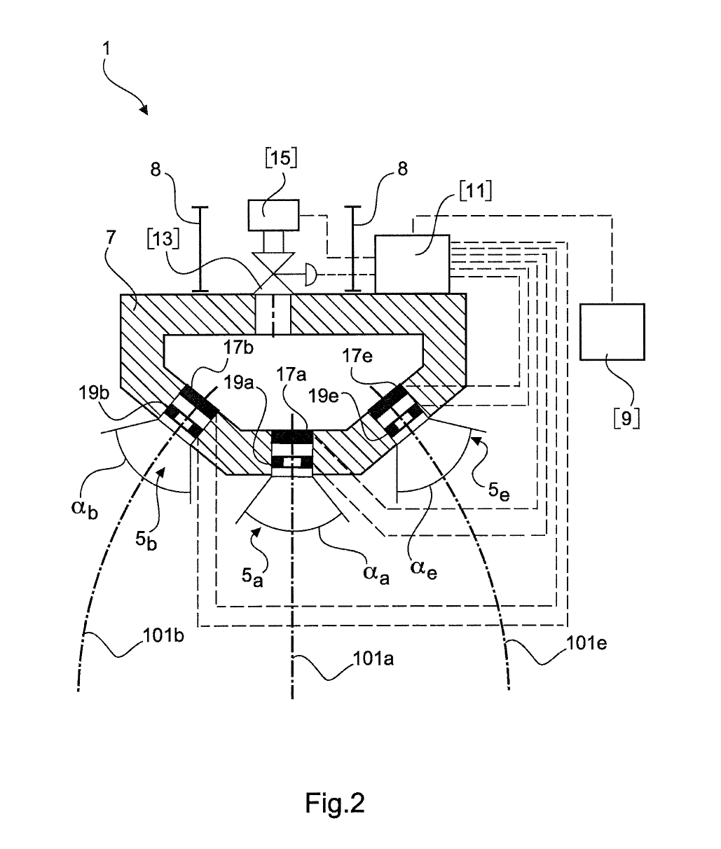

FIG. 2 shows a diagrammatic view of a fire extinguishing device for a fire extinguishing system as shown in FIG. 1a,

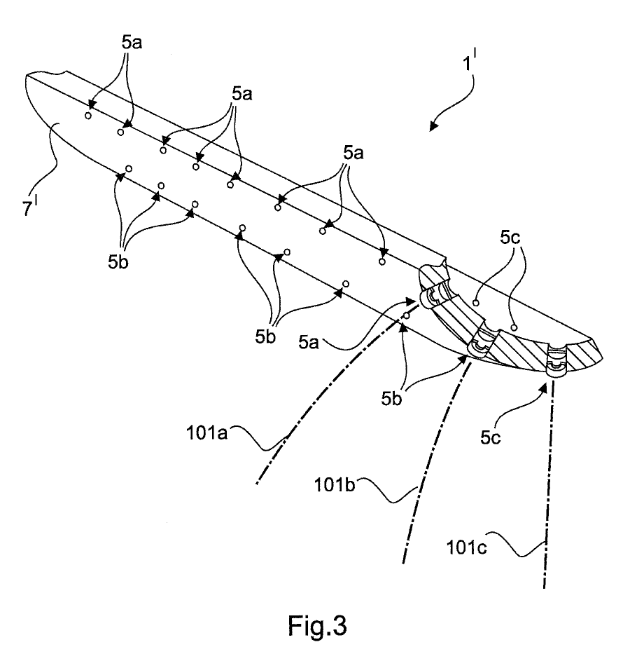

FIG. 3 shows a fire extinguishing device according to a further embodiment, and

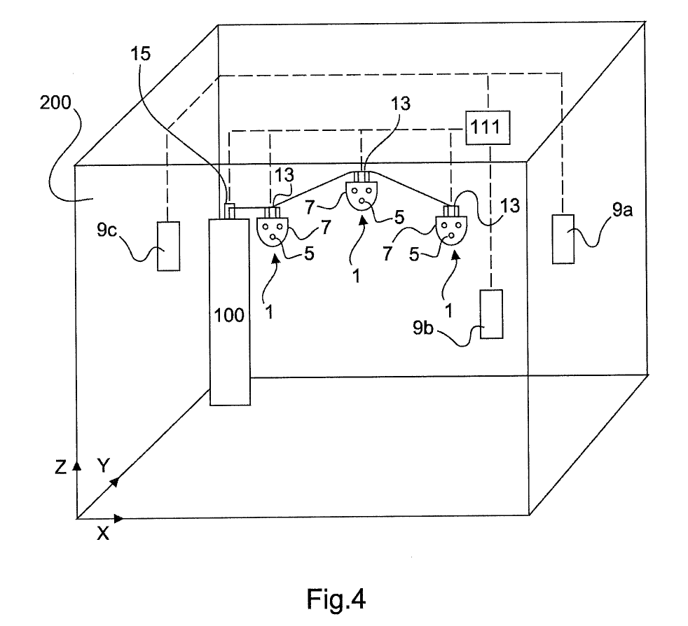

FIG. 4 shows a diagrammatic view of a fire extinguishing system according to a third embodiment.

The fire extinguishing system shown in FIG. 1a is provided for monitoring a room 200. The fire extinguishing system has a fire extinguishing device 1. The fire extinguishing device 1 has an extinguishing fluid inlet 3, by way of which extinguishing fluid passes from an extinguishing fluid supply 100 into a housing 7. The housing 7 has a plurality of extinguishing fluid outlets 5a-f. The extinguishing fluid outlets 5a-f are all oriented in mutually divergent relationship and the orientation of the extinguishing fluid outlets 5a-f is such that associated with each extinguishing fluid outlet 5a-f is an extinguishing fluid trajectory or group of extinguishing fluid trajectories 101a-f which each cover mutually different sectors 203a-f of their own. The sectors 203a-f partially overlap each other, see the hatched regions. Fire sources in the hatched regions are consequently reached by mean of different extinguishing fluid outlets.

The extinguishing fluid outlets 5a-f have respective control members (see FIG. 2) adapted to receive control commands from an electronic control device 11. The electronic control device 11 is connected in signal-conducting relationship to a sensor device 9 which can include one or more sensors. The sensor device 9 is adapted to monitor the room 200 for the presence of a fire source 201. After the fire source 201 has been detected by the sensor device 9 the fire source is characterized in the form of localization information (x; y; z;)_{f} and the localization information is transmitted to the electronic control device. The electronic control device is adapted on the basis of the received localization information to actuate that extinguishing fluid outlet or those extinguishing fluid outlets 5a-f, with whose extinguishing fluid trajectory 100a-f that sector or those sectors in which the identified fire source 201 is disposed is or are covered.

Preferably the electronic control device 11 together with the sensor device 9 is adapted to continuously monitor the development of the fire source. Thus it is possible also to continuously monitor extinguishing success and, if success does not occur or upon a displacement of the fire source 201 into one or more further sectors 203a-f, it is possible to “track” the fire source 201 in accurately target relationship by additionally activating one or more further extinguishing fluid outlets 5a-f. In the embodiment shown in FIG. 1a the fire source 201 is disposed in a first sector 203a. The sensor device 9 identifies that sector 203a, characterizes it by means of localization information (x; y; z;)_{f}, appropriately communicates with the electronic control device 11 which then opens at least the extinguishing fluid outlet 5a. Preferably, depending on the strength and time progression in development of the fire source 201, the electronic control device opens one or more further extinguishing fluid outlets. They could be for example firstly those extinguishing fluid outlets which cover sectors overlapping with the sector 203a which has already been identified, like for example the sector 203e or the sector 203d. That would correspondingly involve the extinguishing fluid outlets 5e, 5d.

The extinguishing device 1 further has a shut-off member 13, by means of which the fluidic communication between the extinguishing fluid inlet 3 and the extinguishing fluid outlet 5a-f can be centrally closed or opened. Preferably the shut-off member is connected in signal-conducting relationship to the electronic control device 11 and is adapted to receive control commands in regard to opening and closing of the shut-off member 13 from the electronic control device 11.

In the illustrated embodiment the shut-off member 13 is arranged downstream of the extinguishing fluid inlet. Alternatively it is equally preferred for the shut-off member 13 to be arranged upstream of the extinguishing fluid inlet, outside the housing 7 on the side towards the extinguishing fluid supply.

Preferably the fire extinguishing device 1 further has a pressure regulator 15. In the configuration shown in FIG. 1a the pressure regulator 15 is arranged downstream of the extinguishing fluid inlet 3. Alternatively it is equally preferred for the pressure regulator 15 to be arranged upstream of the extinguishing fluid inlet 3, particularly preferably in the direction towards the extinguishing fluid supply 100. In that way, and by virtue of the arrangement of the shut-off member 13 in the direction towards the extinguishing fluid supply 100, central control of the flow of fluid for the fire extinguishing device and all extinguishing fluid outlets 5a-f implemented therein is guaranteed. As can also be seen from the example in FIG. 4 that has advantages in regard to control of a plurality of housings 7 in an alternative embodiment.

In those embodiments in which the shut-off member 13 and the pressure regulator 15 are arranged externally upstream the extinguishing fluid inlet is to be located directly at the main body of the housing 7, see the indicated reference 3′.

The electronic control device 11 is preferably integrated in the housing 7 or is arranged in the form of a dedicated unit externally on the housing 7. The electronic control device 11 is interpreted as an internal control device. Preferably the electronic control device 11 is connected in signal-conducting relationship to a fire alarm and/or extinguishing control center 300.

FIG. 1b shows a further diagrammatic view of a fire extinguishing system. The fire extinguishing system of FIG. 1b is structurally similar in many parts to the fire extinguishing system of FIG. 1a, and for that reason reference is directed to the foregoing description in relation to the identical references. Unlike the view in FIG. 1a however the fire extinguishing system of FIG. 1b provides that the electronic control device is in the form of an external control device 111 which is not part of the fire extinguishing device 1. The external electronic control device 111 is either connected in signal-conducting relationship to a fire alarm and/or extinguishing control center 300, or, as indicated by reference 301, it is integrated into a fire alarm and/or extinguishing control center 301. The sensor device 9, in accordance with the definition of FIG. 1b, is also no longer an intrinsic component of the fire extinguishing device 1, but an independent external functional unit. That redistribution of the system components has particular advantages in terms of using not just one fire extinguishing device 1 but a plurality of fire extinguishing devices 1 with a plurality of housings 7 (see FIG. 4).

The fire extinguishing device 1 shown in FIG. 1a is illustrated in greater detail in FIG. 2. The fire extinguishing device 1 has fixing means 8 with which the housing 7 of the fire extinguishing device 1 can be mounted to a wall or ceiling of the room 200.

The pressure regulator 15 and the shut-off member 13 are disposed outside the housing 7, just like the electronic control unit 11 and the sensor device 9.

The extinguishing fluid outlets 5a-f (the extinguishing fluid outlets 5a, 5b and 5e are shown by way of example in the section plane) each have a control member 17a-f adapted to selectively open or close the respective extinguishing fluid outlet 5a-f. For that purpose the control members 17a-f are preferably connected in signal-conducting relationship to the electronic control device 11 and have suitable signal receiving connections for receiving control commands. As part of the control members 17a-f, the extinguishing fluid outlets 5a-f preferably also have a respective throttle 19a-f with which the extinguishing fluid pressure of the issuing extinguishing fluid can be manipulated. Preferably the throttles 19a-f are in the form of aperture means. The opening size of the aperture means or the throttle width of the throttles 19a-f is preferably controllable in specifically targeted fashion, particularly preferably individually, by means of the electronic control device. For that purpose the throttles 19a-f are connected in signal-conducting relationship to the electronic control device 11 and have respective suitable signal receiving means for receiving the control commands.

The extinguishing fluid outlets 5a-f have an outlet geometry with a spread angle α_{a-f} (shown at αₐ, α_{b} and αₑ) that opens in the direction of the extinguishing fluid trajectories 101a-f. The angles α_{a-f} can be identical to each other or can be of different magnitudes, depending on the requirements involved with the room 200 and the sectors 203a-f to be covered.

In the view in FIG. 2 all extinguishing fluid outlets 5a-f are oriented in mutually divergent relationship so that the extinguishing fluid trajectories 101a-f discharged thereby do not extend parallel to each other.

The electronic control device 11, the sensor devices 9, the shut-off member 13 and the pressure regulator 15 are optional components which, in an arrangement as shown in FIG. 1a, are associated with the fire extinguishing device 1. In the case of systems which require an external electronic control device, the electronic control device 11 would accordingly be replaced at any event by an external electronic control device 111, and also the components sensor device 9, shut-off member 13 and pressure regulator 15 would sometimes be associated with the fire extinguishing system but not the individual fire extinguishing device 1, which also predestines a use of the fire extinguishing device 1 for systems like for example as shown in FIG. 1b and FIG. 4.

As a development of this embodiment FIG. 3 shows an alternative geometry of a fire extinguishing device 1. In the FIG. 3 view not all extinguishing fluid outlets are oriented in mutually divergent relationship. A number of first extinguishing fluid outlets 5a are oriented in mutually parallel relationship. Equally a number of second extinguishing fluid outlets 5b are oriented in mutually parallel relationship. Furthermore a number of third extinguishing fluid outlets 5c are arranged in mutually parallel relationship. Depending on the respective spatial configuration of the housing 7′ of the fire extinguishing device 1′ the housing 7′ has one or more number of further extinguishing fluid outlets which are not shown here for the purposes of simple explanation.

The first extinguishing fluid outlets 5a are oriented divergently relative to the second and third extinguishing fluid outlets 5b, c so that the extinguishing fluid trajectory 101a is not oriented parallel to the extinguishing fluid trajectories 101b and 101c. The same respectively applies in similar fashion to the second and third extinguishing fluid outlets 5b, c. In regard to the further technical details attention is directed to the embodiment shown in FIG. 2.

While FIGS. 1a, b respectively show a fire extinguishing system having a singular fire extinguishing device 1 FIG. 4 shows an alternative preferred embodiment in which a plurality of fire extinguishing devices 1 are installed in the room 200. The fire extinguishing devices 1 each have a shut-off member 13. The fire extinguishing devices 1 and the shut-off members 13 are connected in signal-conducting relationship to an external electronic control device 111 similarly to the actuating arrangement shown in FIGS. 1a, b, in particular with reference to FIG. 1b. The central external electronic control device 111 is further connected in signal-conducting relationship to a first, second and third sensor device 9a, b, c positioned at various locations in the room 200. The fire extinguishing system of FIG. 4 further has an extinguishing fluid supply 100 with a central pressure regulator 15, by way of which the extinguishing fluid supply for the fire extinguishing devices 1 is controlled. Otherwise actuation of the extinguishing fluid outlets 5 is effected substantially as described hereinbefore with reference to the previous Figures and preferred embodiments. The fire extinguishing devices 1 can alternatively also be fire extinguishing devices 1′ as shown in FIG. 3.

### LIST OF REFERENCES

1 fire extinguishing device
3 extinguishing fluid inlet
5(a-f) extinguishing fluid outlet
7, 7′ housing
8 fixing means
9 sensor device
11, 111 electronic control device
13 shut-off member
15 pressure regulator
17(a-f) control member for opening or closing the extinguishing fluid outlet 5
19(a-f) throttle
100 extinguishing fluid supply
101(a-f) extinguishing fluid trajectory
200 room
201 source of the fire
203(a-f) sector
300 fire alarm and/or extinguishing control center
301 extinguishing control center
(x; y; z;)_{f} localization data
α_{a-f} spread angle

1. A fire extinguishing device (1; 1′) for installation in a room (200) and for fighting fires in a plurality of sectors of the room, comprising a housing (7) having an extinguishing fluid inlet (3), wherein the housing has a plurality of extinguishing fluid outlets (5a-f) fluidically connected to the extinguishing fluid inlet, wherein the extinguishing fluid outlets (5a-f)
are adapted to discharge an extinguishing fluid along a respective individual extinguishing fluid trajectory (101a-f),
are oriented fixedly on the housing in such a way that the extinguishing fluid trajectories from the extinguishing fluid outlets cover respectively different sectors (203a-f) of the room, and
associated with the extinguishing fluid outlets is a respective control member (17a-f) for selectively opening or closing the connection between extinguishing fluid inlet and extinguishing fluid outlet.

2. A fire extinguishing device (1; 1′) as set forth in claim 1 wherein the control members (17a-f) are adapted for individual, preferably stepless, control of the pressure of the extinguishing fluid discharged through the extinguishing fluid outlets (5a-f).

3. A fire extinguishing device (1) as set forth in claim 1 including at least one sensor device (9) for localization that or those sectors (203a-f) of the room (200), that have a source of fire (201) and for producing localization information in respect of those sectors.

4. A fire extinguishing device (1′) as set forth in claim 1 including a data interface for actuation of the control members (17a-f) by means of an external electronic control device (111).

5. A fire extinguishing device (1) as set forth in claim 3 including an electronic control device (11) which is connected in signal-conducting relationship to the at least one sensor device (9) on the one hand and the control members (17a-f) on the other hand, wherein the at least one sensor device (9) is adapted to communicate the localization information to the electronic control device (11).

6. A fire extinguishing device (1) as set forth in claim 5 wherein the electronic control device (11) is adapted
on the basis of the localization information to identify one or more of the extinguishing fluid outlets (5a-f) whose respective extinguishing fluid trajectory (101a-f) covers a located sector (203a-f), and
to open the identified extinguishing fluid outlet or outlets (5a-f).

7. A fire extinguishing device (1) as set forth in claim 6 wherein the electronic control device (11) is adapted
on the basis of the received localization information to track the extinguishing process,
in addition to the identified extinguishing fluid outlet or outlets (5a-f) to open one or more further, in particular respectively adjacent, extinguishing fluid outlets, and
to close one, several or all extinguishing fluid outlets.

8. A fire extinguishing device (1) as set forth in claim 7 wherein the control members (17a-f) each have a respective throttle (19a-f) in the form of an aperture means for adjusting the pressure of the issuing extinguishing fluid.

9. A fire extinguishing device (1) as set forth in claim 8 wherein the throttles (19a-f) are in the form of replaceable elements.

10. A fire extinguishing device (1) as set forth in claim 8 wherein the throttles (19a-f) each have a respective adjusting means for changing the throttle width.

11. A fire extinguishing device (1) as set forth in claim 1 wherein the control members (5a-f) are each of a respective discharge cross-section adapted for discharge of an extinguishing fluid pattern which enlarges in the direction of the extinguishing fluid trajectory.

12. A fire extinguishing device (1) as set forth in claim 1 wherein all extinguishing fluid outlets (5a-f) are oriented in mutually divergent relationship.

13. A fire extinguishing device (1) as set forth in claim 1 comprising three or more extinguishing fluid outlets (5a, b, c), wherein two or more first extinguishing fluid outlets (5a) are oriented in mutually parallel relationship and one or more second extinguishing fluid outlets (5b) are oriented in mutually parallel relationship but in divergent relationship with the first extinguishing fluid outlets (5a).

14. A fire extinguishing device (1) as set forth in claim 1 comprising a pressure regulator (15) which is fluidically interposed between the extinguishing fluid inlet and the extinguishing outlets and which is adapted to increase or reduce, selectively, the extinguishing fluid pressure at the inlet side.

15. A fire extinguishing device (1) as set forth in claim 3 wherein the at least one sensor device (9) is arranged in a separate housing in spaced relationship with the housing (7) of the fire extinguishing device.

16. A fire extinguishing device as set forth in claim 1 comprising fixing means for installation of the housing on an object, a wall or a ceiling of a room.

17. A fire extinguishing system comprising an extinguishing fluid supply (100),
at least one fire extinguishing device (1) fluidically connected to the extinguishing fluid supply,
wherein the fire extinguishing device is in accordance with claim 1.

18. A fire extinguishing system as set forth in claim 17 wherein the extinguishing fluid supply (100) is a water supply installed in a building, or is in the form of a pressurized extinguishing fluid supply or is in the form of a pressure-less container connected to a separately provided pressurized propellant container and the extinguishing agent of which can be expelled by means of the propellant.
